(19) United States
(12) Patent Application Publication
(10) Pub. No.: US 2013/0278036 A1
(43) Pub. Date: Oct. 24, 2013

(54) VEHICLE SEAT FOR A MOTOR VEHICLE

(71) Applicant: GM GLOBAL TECHNOLOGY OPERATIONS LLC, Detroit, MI (US)

(72) Inventor: Christopher WORDEN, Ruesselsheim (DE)

(73) Assignee: GM GLOBAL TECHNOLOGY OPERATIONS LLC, Detroit, MI (US)

(21) Appl. No.: 13/797,441

(22) Filed: Mar. 12, 2013

(30) Foreign Application Priority Data
Apr. 20, 2012 (DE) 102012007978.8

(51) Int. Cl. B60N 2/22

(52) U.S. Cl. CPC B60N 2/22
USPC 297/362.11

(57) ABSTRACT

A vehicle seat for a motor vehicle is provided. The vehicle seat includes a seat frame, a backrest and a backrest adjuster having a pivot axis, a first fitting and a second fitting for adjusting an inclination angle of the backrest. The vehicle seat also includes a switch, which activates a drive at particular inclination angles of the backrest, in order to move the vehicle seat forward or backward. The switch is arranged beneath the pivot axis in the outer region of the first fitting.

### CROSS-REFERENCE TO RELATED APPLICATION

This application claims priority to German Patent Application No. 10 2012 007 978.8, filed Apr. 20, 2012, which is incorporated herein by reference in its entirety.

### TECHNICAL FIELD

This application pertains to a vehicle seat for a motor vehicle with a seat frame, a backrest, a backrest adjuster having a pivot axis, a first fitting and a second fitting, for adjusting an inclination angle of the backrest, with a switch, which activates a drive at particular inclination angles of the backrest, in order to move the vehicle seat forward or back.

### BACKGROUND

A generic vehicle seat is known from the prior art, in which the switch is arranged in the vehicle seat between the seat frame and the second fitting, which is fastened to the backrest. The switch extends along the transverse axis of the vehicle and detects the relative movement of the second fitting relative to the seat frame. The mounting of the switch at this site necessitates a relatively high degree of effort in mounting and of required space.

In addition, other objects, desirable features and characteristics will become apparent from the subsequent summary and detailed description, and the appended claims, taken in conjunction with the accompanying drawings and this background.

### SUMMARY

The present disclosure provides an improved vehicle seat to the effect that a switch is simple to mount.

In this regard, the present disclosure provides a vehicle seat for a motor vehicle with a seat frame, a backrest, a backrest adjuster having a pivot axis, a first fitting and a second fitting for adjusting an inclination angle of the backrest, with a switch, which actives a drive at particular inclination angles of the backrest, in order to move the vehicle seat forward or back, wherein the switch is arranged beneath the pivot axis in the outer region of the first fitting. This position is very easily accessible for mounting. In addition, it offers a certain installation space which can not be used for other components, because it is only relatively small.

The switch can have a sensing element, which detects the inclination angle of the backrest. In this way, the inclination angle can be determined precisely.

The second fitting can have a switching cam, so that the switch can switch reliably at a quite specific inclination angle.

In order to save installation space and to be able to therefore arrange the switch beneath the pivot axis in the outer region of the seat frame, the sensing element can be movable at least approximately parallel to the outer side of the first fitting.

The sensing element can be bent such that its free end is able to be applied against the second fitting. In this way, the inclination angle of the backrest can be determined reliably, and namely also when the second fitting, on pivoting of the backrest, carries out an oscillating movement relative to the pivot axis.

The switch can be able to be arranged on a carrier element, and the carrier element on the seat frame. Therefore, the switch can be pre-mounted on the carrier element before the carrier element is fastened to the seat frame.

The carrier element can have a fastening arrangement for a fabric cover of the vehicle seat. Alternatively or additionally, the carrier element can have a fastening arrangement for a cover facing of the vehicle seat, which can be made from plastic. Therefore, the carrier element fulfills several functions simultaneously.

The switch can be arranged between the carrier element and the first fitting. Therefore, it is protected from external influences.

On switching over from one movement direction of the vehicle seat to an opposite movement direction, the switch can have a time delay. The time delay can generally be about half a second. Therefore, it is ensured that a constant moving to and fro of the backrest about the angle at which the drive is activated into the one or other movement direction, can not destroy the drive.

So that the backrest can be adjusted for comfortable sitting, without the drive being activated inadvertently, the switch can only be able to be activated in an angle range which lies outside a comfort range in which a person can sit and rest comfortably.

In order to be able to arrange the switch beneath the pivot axis in the outer region of the seat frame, it is advantageous if the switch is a microswitch.

The activating angle at which the drive is able to be activated can be set on the switch. Therefore, the microswitch can be a standardized component which can be used for various seat constructions and can be set so as to be suitable for these.

The present disclosure further relates to a motor vehicle, wherein it has the vehicle seat according to the various teachings of the present disclosure.

A person skilled in the art can gather other characteristics and advantages of the disclosure from the following description of exemplary embodiments that refers to the attached drawings, wherein the described exemplary embodiments should not be interpreted in a restrictive sense.

### BRIEF DESCRIPTION OF THE DRAWINGS

The various embodiments will hereinafter be described in conjunction with the following drawing figures, wherein like numerals denote like elements, and wherein:

FIG. 1 is the diagrammatically illustrated vehicle seat in a first backrest position;

FIG. 2 is the vehicle seat of FIG. 1 in a second backrest position;

FIG. 3 is a detail view of the vehicle seat in the region of a switch;

FIG. 4 is a diagrammatic detail view in the region of the switch;

FIG. 5 is a pivoting range of a backrest;

FIG. 6 is a perspective view onto a carrier element; and,

FIG. 7 is a detail view of the vehicle seat and of the mounted carrier element.

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

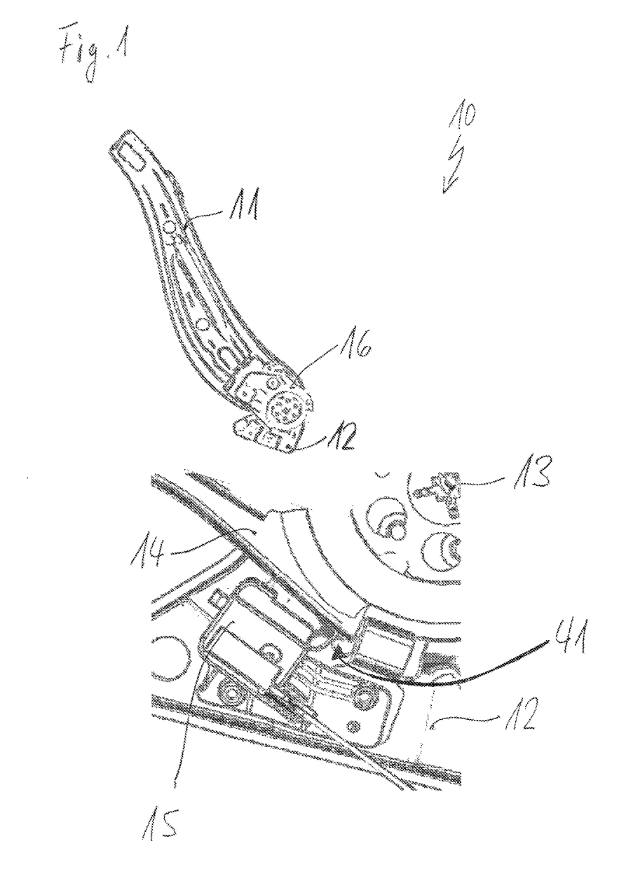

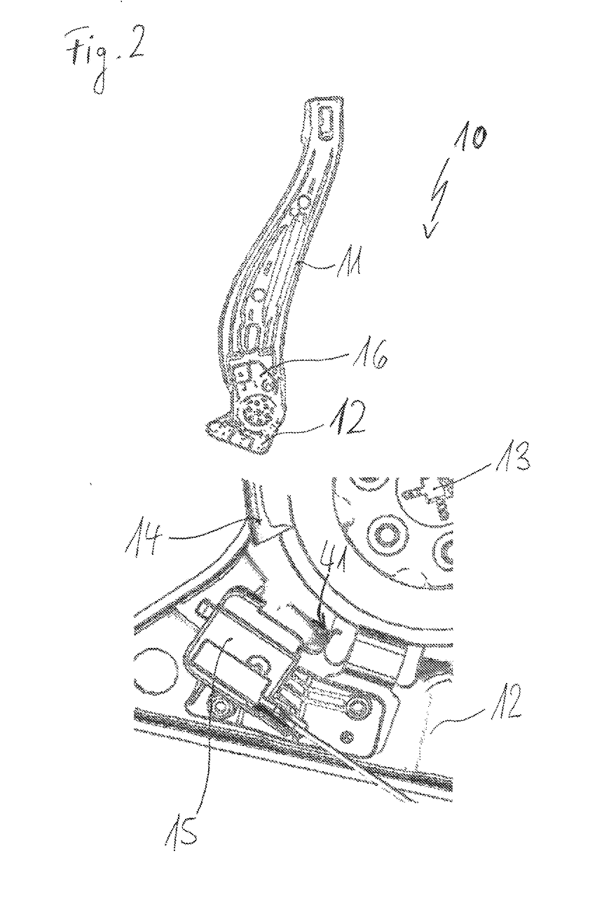

FIGS. 1 and 2 show a vehicle seat 10 with a backrest 11 and a seat frame, which is not illustrated for reasons of clarity. The seat frame is arranged beneath the backrest 11 and can receive an upholstered seat surface, which is also not illustrated. The backrest is able to be pivoted in longitudinal direction of the vehicle about a pivot axis 13 forward (see FIG. 1) and backward (see FIG. 2).

A first fitting 12 is arranged on the seat frame and a second fitting 16 is arranged on the backrest 11. When the backrest 11 is pivoted about a certain inclination angle forward or backward, a switch 15 is actuated by means of a switching cam 14 arranged on the second fitting 16, which switch activates a drive, which is not illustrated in further detail here, in order to move the vehicle seat 10 forward or backward.

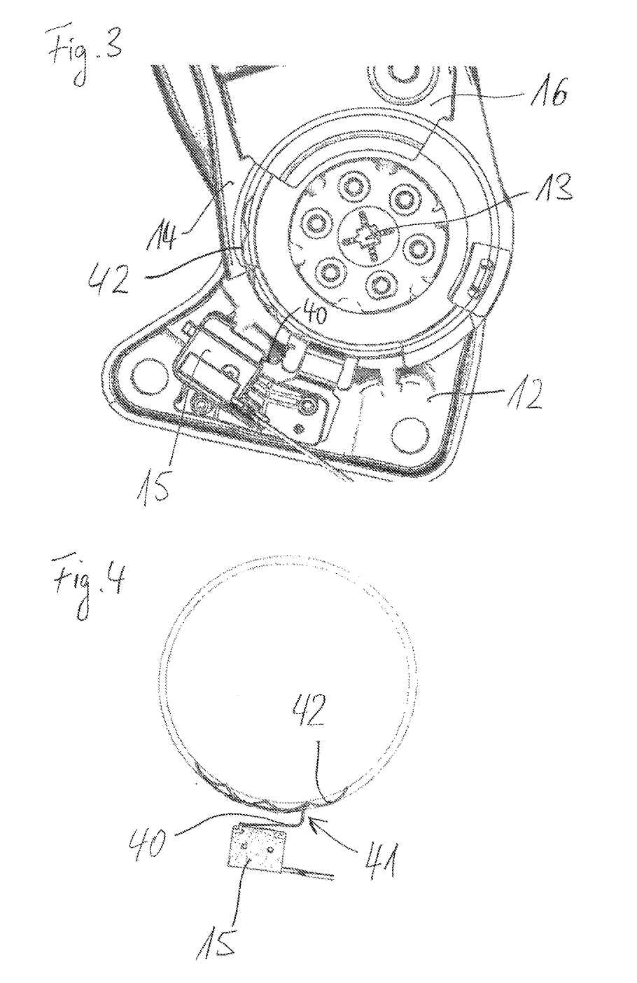

The switch 15, which is microswitch, is mounted beneath the pivot axis 13 in the outer region of the first fitting 12. It has a sensing element 40, which is movable parallel to the outer side of the first fitting 12 (see FIGS. 3 and 4). The sensing element 40 has a free end 41, which is able to be applied on the second fitting 16 (see FIGS. 1, 2 and 4). Therefore, the inclination angle of the backrest 11 can also be reliably determined when the second fitting 16, on pivoting of the backrest 11 relative to the pivot axis 13 carries out an oscillating movement in accordance with a movement path 42 (see FIGS. 3 and 4).

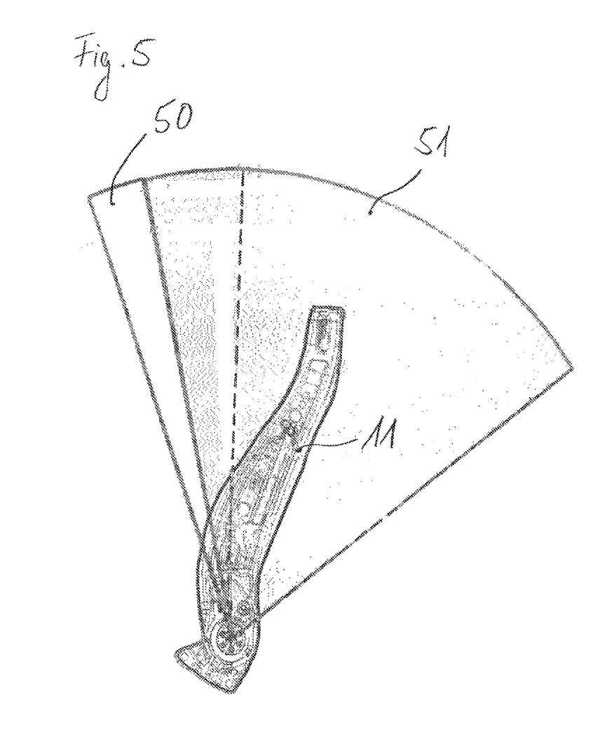

In order to be able to adjust the backrest 11 for comfortable sitting, without the drive being inadvertently activated for adjusting the vehicle seat 10, the switch 15 can only be able to be activated in an angle range 50 which lies outside a comfort range 51, in which a person can sit and rest comfortably (see FIG. 5).

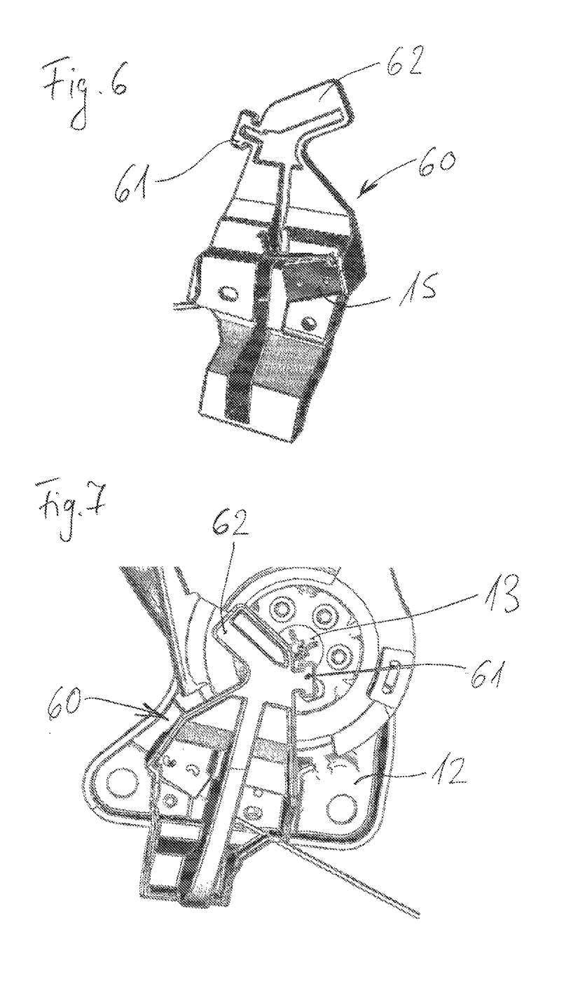

The switch 15 can be arranged on a carrier element 60, which is arranged together with the switch 15 beneath the pivot axis 13 (see FIGS. 6 and 7). The switch 15 can be arranged between the carrier element 60 and the first fitting 12. The carrier element 60 therefore covers the switch 15 and in this way protects it from external influences.

The carrier element 60 is provided with a fastening arrangement 61 which is constructed in a hook shape in order to fasten a fabric cover, which is not illustrated in further detail here, to the vehicle seat 10. In addition, the carrier element has a fastening arrangement 62, in order to mount a cover facing, likewise not shown, onto the vehicle seat 10.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

What is claimed is:

1. A vehicle seat for a motor vehicle, comprising:
a seat frame;
a backrest;
a backrest adjuster having a pivot axis, a first fitting and a second fitting for adjusting an inclination angle of the backrest; and
a switch, which activates a drive at particular inclination angles of the backrest, in order to move the vehicle seat forward or backward,
wherein the switch is arranged beneath the pivot axis in the outer region of the first fitting.

2. The vehicle seat according to claim 1, wherein the switch has a sensing element, which detects the inclination angle of the backrest.

3. The vehicle seat according to claim 2, wherein the second fitting has a switching cam in order to switch the switch.

4. The vehicle seat according to claim 3, wherein the sensing element is movable at least approximately parallel to the outer side of the first fitting.

5. The vehicle seat according to claim 4, wherein the sensing element is bent such that its free end is able to be applied on the second fitting.

6. The vehicle seat according to claim 5, wherein the switch is able to be arranged on a carrier element and the carrier element on the seat frame.

7. The vehicle seat according to claim 6, wherein the carrier element has a fastening arrangement for a fabric cover of the vehicle seat.

8. The vehicle seat according to claim 6, wherein the carrier element has a fastening arrangement for a cover facing of the vehicle seat.

9. The vehicle seat according to claim 6, wherein the switch is able to be arranged between the carrier element and the first fitting.

10. The vehicle seat according to claim 1, wherein the switch has a time delay on switching over from one movement direction of the vehicle seat to an opposite movement direction.

11. The vehicle seat according to claim 1, wherein the switch is only able to be activated in an angle range which lies outside a comfort range for a person to sit and rest comfortably.

12. The vehicle seat according to claim 1, wherein the switch is a microswitch.

13. The vehicle seat according to claim 1, wherein the activating angle at which the drive is able to be activated is able to be set on the switch.

14. A motor vehicle, comprising:
a vehicle seat including a seat frame, a backrest, a backrest adjuster having a pivot axis, a first fitting and a second fitting for adjusting an inclination angle of the backrest, a switch, which activates a drive at particular inclination angles of the backrest, in order to move the vehicle seat forward or backward, and the switch is arranged beneath the pivot axis in the outer region of the first fitting,
wherein the switch is able to be arranged on a carrier element and the carrier element on the seat frame.

15. The motor vehicle according to claim 14, wherein the switch is able to be arranged between the carrier element and the first fitting.

16. The motor vehicle according to claim 14, wherein the switch has a time delay on switching over from one movement direction of the vehicle seat to an opposite movement direction.

17. The motor vehicle according to claim 14, wherein the switch is a microswitch.

18. The motor vehicle according to claim 14, wherein the activating angle at which the drive is able to be activated is able to be set on the switch.

19. The motor vehicle according to claim 14, wherein the switch has a sensing element, which detects the inclination angle of the backrest.

20. The motor vehicle according to claim 19, wherein the second fitting has a switching cam in order to switch the switch.
